(19) United States
(12) Patent Application Publication
(10) Pub. No.: US 2019/0289802 A1
(43) Pub. Date: Sep. 26, 2019

(54) PLANTING SYSTEM

(71) Applicant: Bo-Mer Plastics, LLC, Auburn, NY (US)

(72) Inventors: Thomas R. Herbert, JR., Auburn, NY (US); Robert Alan Buckley, Geneva, NY (US)

(73) Assignee: Bo-Mer Plastics, LLC, Auburn, NY (US)

(21) Appl. No.: 16/281,292

(22) Filed: Feb. 21, 2019

Related U.S. Application Data
(60) Provisional application No. 62/646,157, filed on Mar. 21, 2018.

(51) Int. Cl. A01G 27/06; A01G 29/00

(52) U.S. Cl. CPC A01G 27/06; A01G 9/02; A01G 29/00

(57) ABSTRACT

A planting system for irrigating, aerating and delivering a supply of a growth promoting fluid to a potted plant. The planting system comprises a container defining a reservoir for storing a supply of growth promoting fluid and a cavity for holding a quantity of growing medium. The planting system further comprises a wick assembly configured to convey a flow of the growth promoting fluid to the growing medium in the plant cavity. The wick assembly includes first and second portions which are in fluid communication by a wicking medium. The first portion includes a first end of the wicking medium which is disposed in the reservoir to absorb the growth promoting fluid. The second portion including a second end of the wicking medium disposed in the plant cavity and in contact with the growing medium.

### CROSS-REFERENCE TO RELATED APPLICATIONS

This application claims the benefit of the filing date and priority of U.S. Provisional Patent Application No. 62/646,157, (Docket No.: 3091862US01) filed Mar. 21, 2018, entitled “PLANTER SYSTEM”. The complete specification of this application is hereby incorporated by reference in its entirety.

### TECHNICAL FIELD

The subject matter disclosed herein is directed to a new and useful system for growing annual/perennial plants, ferns, and or vegetables, and more particularly, to a system for planting such photosynthetic organisms in a self-irrigating planting system.

### BACKGROUND

Planters are commonly used for growing plants (e.g., flowers, vegetables, etc.) in a container, i.e., for receiving soil, water, nutrients, seeds and/or seedlings for growth. In order to nurture and promote the health and growth of a plant, the soil and/or nutrients must be kept moist by frequent watering, whether from natural (e.g., rain), automatic (e.g., sprinkler), or manual means (e.g., pouring water into the plant container.) The need for maintaining moisture can present difficulties to plant owners, who must either position the plant within range of an automatic sprinkler, or be available, or have others available, to provide water to the growing plant on a regular/routine basis.

For plants requiring water on a frequent, i.e., daily, basis, including plants located in areas that are difficult to provide a steady supply of water, the health of a plant can be compromised when those tending to the care of the plant are unavailable (e.g., due to vacation or other travel) during which time the plant and surrounding soil may become dry. On the other hand, the requirement for daily and/or frequent watering can lead to an excess supply of water, representing a hazardous condition for the plant along with waste due to evaporation.

The foregoing background describes some, but not necessarily all, of the problems, disadvantages and shortcomings related to the irrigation/watering of a potted plant.

### SUMMARY

In one embodiment, a planting system is disclosed for irrigating, aerating and delivering a supply of a growth promoting fluid to a potted plant. The planting system comprises a container defining a reservoir for storing a supply a growth promoting fluid and a cavity for holding a quantity of growing medium. The planting system further comprises a wick assembly configured to convey a flow of the growth promoting fluid to the growing medium in the plant cavity. The wick assembly includes first and second portions which are in fluid communication by a wicking medium. The first portion includes a first end of the wicking medium which is disposed in the reservoir to absorb the growth promoting fluid. The second portion including a second end of the wicking medium disposed in the plant cavity and in contact with the growing medium.

In another embodiment, a method is provided for self-irrigating a potted plant comprising the steps of: (i) configuring a container so as to produce a cavity for holding a growing medium and a reservoir for containing a growth promoting fluid; (ii) configuring a wick assembly with a wicking medium for conveying the growth promoting fluid from the reservoir to the growing medium, and (iii) configuring the wick assembly with a tubular column at one end and a planar irrigation tray at the other end. The cylindrical cavity is configured to receive one end of the wicking medium for absorbing the growth promoting fluid from the reservoir. The irrigation tray is configured to receive a second end of the wicking medium beneath the growing medium for transferring the growth promoting fluid to the growing medium.

Additional features and advantages of the present disclosure are described in, and will be apparent from, the following Brief Description of the Drawings and Detailed Description.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 depicts a partially broken-away perspective view of an exemplary embodiment of a planter system including: (i) a cavity for containing a potting soil and a reservoir disposed beneath and surrounding the cavity, (ii) a barometric tube disposed within the reservoir for preventing an overfill condition, and (iii) a wick assembly disposed within the cavity and in contact with the potting soil for providing the plant with a continuous and steady flow of water for irrigating the potting soil to promote growth and maintain the health of the potted plant.

FIG. 2 depicts an isolated perspective view of the wick assembly of the planter system including: (i) a tubular column for receiving a supply of water/growth promoting fluid, (ii) a planting tray for receiving and supporting at least a portion of the potting soil, and (iii) an absorbent wick disposed within a cavity of the tubular column for delivering the supply of water/growth promoting fluid to the potted soil.

FIG. 3. depicts a top view of the wick assembly shown in FIG. 2 including the absorbent wicking material: (i) filling/lining the cavity of the tubular column and (ii) extending radially outboard from the axis of the tubular column.

FIG. 4 depicts an alternative embodiment of a planter system wherein a conventional planter is retrofit in combination with the wick assembly of the present disclosure.

FIG. 5 is a cross-sectional view of the alternative embodiment taken substantially along line 5-5 of FIG. 4.

FIG. 6 illustrates an exploded top perspective view of a planter system according to another embodiment of the disclosure.

FIG. 7 illustrates a side exploded view of the planter system of FIG. 6 including a thermoformed planter, a thermoformed insert and a tapered wick.

FIG. 8 illustrates an assembled cross-sectional view of the planter system of FIG. 6 wherein the thermoformed insert defines an annular reservoir for retaining the water fed to the plant.

FIG. 9 depicts a broken-away cross-sectional view of the planter system of FIG. 6 to reveal the relevant internal details thereof.

### DETAILED DESCRIPTION

The present disclosure is directed to a self-irrigating planting system (hereinafter the terms ‘planting system” and “planter” will be used interchangeably), and wick assembly therefor. The planter 100 can be provided in a variety of sizes and stylized shapes, including a cube, rolled rim, rectangular, square and round planters. It should also be appreciated that the planter 100 may be molded as a single integrated component, or as separate subcomponents which may be subsequent joined or assembled.

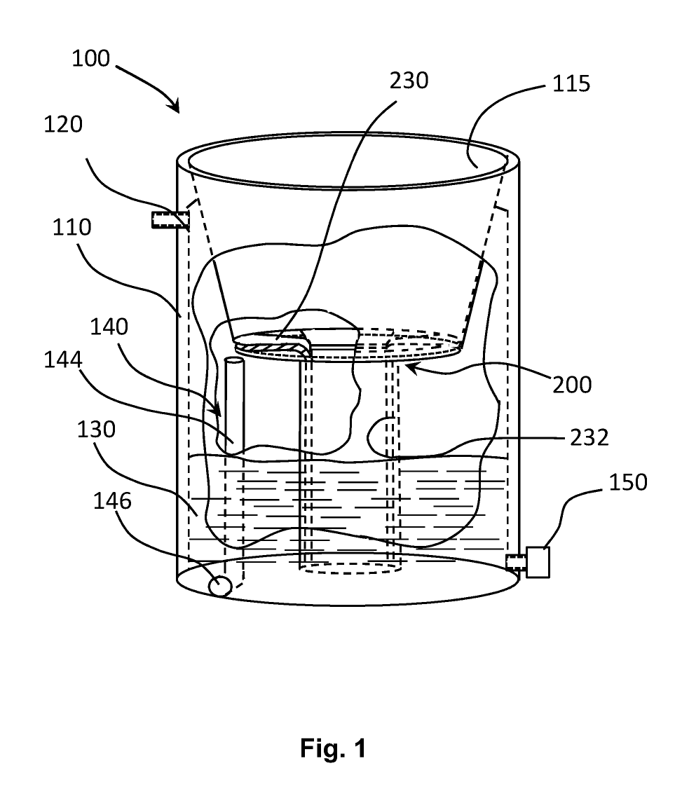

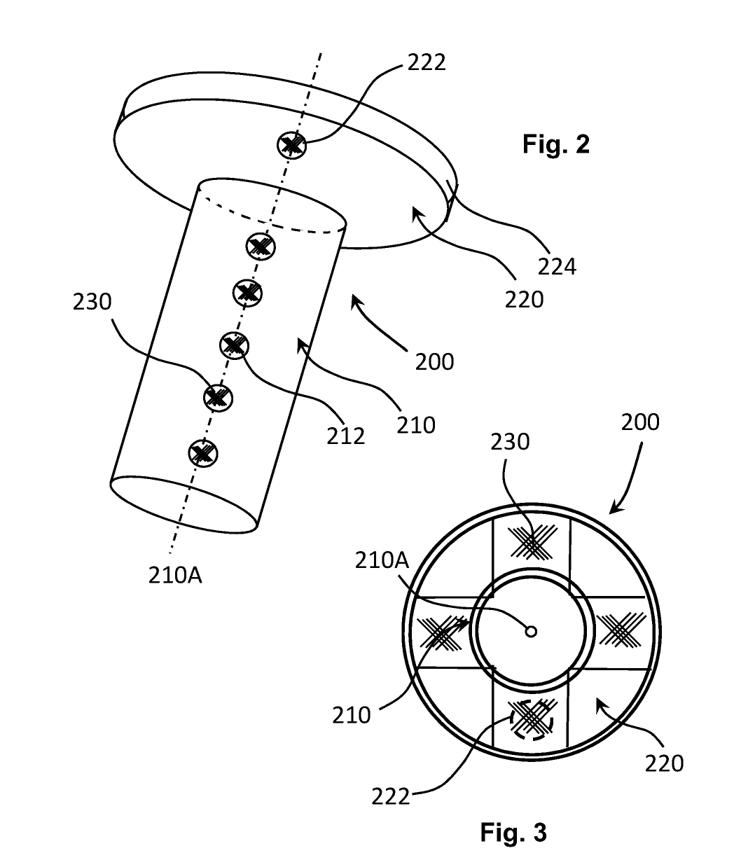

In FIGS. 1-3, the planting system 100 is broken-away to reveal the relevant internal details. The planting system 100 comprises a primary vessel or container 110 defining a plant cavity 115 for receiving potting soil or medium (not shown) and a photosynthetic organism (also not shown) for growing or thriving in the growing medium. Additionally, the primary container 110 includes a reservoir 130 where water is stored. The planting system 100 and container 110 can be sized to provide a wide range of volumetric variation (e.g., a range from about 3.5 gallons to about 27.0 gallons). Depending on the environmental conditions, a planting system 100 according to the teachings of the present disclosure can provide irrigation for several weeks, hence, the need for daily or weekly watering can be eliminated in favor of a much reduced maintenance regiment.

In one embodiment, the container 110 can be fabricated with an average wall thickness of about 0.125″ (3.175 mm) for durability. In this embodiment, the container 110 can be manufactured using a rotational molding process to ensure that a greater wall thickness can be provided in certain regions. For example, it may be desirable to increase the wall thickness at the bottom or base of the container 110 to improve durability. In addition, the rotational molding process can be used to ensure that the color of the container 110 is consistent in vividness, uniformity, and texture.

A connector 120 (or molded-in feature) can be located at the top of the container 110 for filling the reservoir 130 with a water. An overflow assembly 140 may be provided to prevent the reservoir 130 from being overfilled. In the illustrated embodiment, the overflow assembly 140 may comprise a conduit 144 that allows water to flow through the conduit 144 and out of the container 110 through an overflow aperture 146 in the container 110 when the level of the water in the reservoir 130 exceeds the vertical height of the conduit 144. A drain plug 150 may be located on the side of the container 110 for easy access to allow drainage of water from the reservoir 130 when required.

The planting system 100 also comprises a wick assembly 200 for supplying/transferring water from the reservoir 130 to the potted plant. More specifically, the wick assembly 200 comprises a molded housing having a tubular column 210, an irrigation tray 220 and a wicking medium 230. While the described embodiment depicts a cylindrical column 210, it will be appreciated that a variety of other shapes may be employed depending upon the aesthetics of the potting vessel. For example, the column may have a square, rectangular or other polygonal shape. Additionally, the cross-sectional shape may vary along the longitudinal axis 210A of the column 210.

The tubular column 210 is configured to receive a quantity of growth promoting fluid, e.g., water or premixed solution of specialized plant nutrients, through at least one aperture 212 disposed through a wall of the molded housing 205. In the described embodiment, a plurality of apertures 212 are disposed along the longitudinal axis 210A of the column 210 and along the underside of the irrigation tray 220. The irrigation tray 220 is formed by a planar tray which is substantially normal to the longitudinal axis 210A of the cylindrical column 210. The irrigation tray 220 is configured to receive and support the growing medium, i.e., garden or potting soil, disposed within the cavity 115 of the container 110.

More specifically, the wick assembly 200 comprises first and second portions 212, 222 which are in fluid communication via the wicking medium 230. The first portion 212 is disposed within the reservoir 130 of the container 110 to absorb the growth promoting fluid. The second portion 222 is disposed in the plant cavity 115 and contacts the growing medium which is irrigated in response to the wicking action of the wicking medium. In the described embodiment, the wicking medium 230 is disposed within the tubular cavity 232 and absorbs the growth promoting fluid though apertures 212 disposed through the wall of the tubular column 212. Furthermore, the wicking medium 230 is laid flat between the planting tray 220 and the potting soil. That is, the wicking medium 230 fans outwardly from the tubular column to form a planar end portion which functions as an interface for transferring the growth promoting fluid to the growing medium.

In the described embodiment, the wicking medium 230 lines the tubular cavity 232 but does not fill the volume in its entirety. Rather, additional volume is provided for root growth down the center of the tubular column. In addition to providing room for root growth, the tubular cavity 232 provides additional surface area for fluid transfer and aeration of the plant roots. As such, the wicking medium 230 provides a self-irrigating flow of growth promoting fluid from the first portion 210 to the second portion 220 of the wick assembly 200. Additionally, the wicking medium 230 facilitates a prolonged irrigation of the soil by delivering a steady constant flow of growth promoting fluid from the reservoir 130 to the growing medium via the wick assembly 200.

As will be explained in the subsequent paragraphs, the wicking medium 230 comprises reclaimed, cut pile, carpet fabric which functions as a carrier for transferring water or other growth promoting fluid in the reservoir 130 vertically by capillary action to the planting or irrigation tray 220 of the wick assembly 200. A steady supply of moisturizing fluid is, therefore, carried from the tubular column 210 to the planting tray 220 to supply the plant roots, located proximal to the interface between the planting tray 220 and the potting soil, with a nurturing flow of growth promoting fluid.

In one embodiment, the cut pile carpet fabric 230 is made of a polyolefin, (polypropylene or polyethylene) or nylon based material. The wicking medium 200, including the tube 210, the planting tray 220, and the cut pile carpet fabric 230, can be made in a variety of lengths, widths, shapes, forms, and configurations suitable for use in the planting system 100. The planting tray 220 includes a rim 224 bounding a planar top surface which is substantially normal to the longitudinal axis 210A of the tubular column 210. In addition to providing apertures 212 for absorption of fluid, the apertures also promote aeration and air circulation within and around the roots of the potted plant.

In one embodiment, the growing medium may be a fine ground peat moss or another soil-less mixture. The growing medium may include fertilizer or other additives to promote plant growth. The individual piles of the wicking medium 230 can be spread apart and loaded with fine ground peat moss around each yarn strand, i.e., down to the base of each yarn strand. When water is applied to the growing medium, it acts like a sponge, expanding and swelling to hold nearly nine (9) times its weight in water.

When combined with the wicking medium 230, the growing medium creates a wicking action that has the ability to raise water by a capillary action to a vertical height of about twenty-four (24) inches above the water level. Additionally the wicking medium 230, while surrounded with the water laden growing medium have the ability to entrap air in the center of the cut pile which promotes oxidation for the plant roots.

When the wicking medium 230 is placed in the reservoir of the container, the wicking medium 230 transfers moisture from the wet source to the dry medium. As environmental conditions (e.g., rain, sun, temperature, humidity, wind, airflow, etc.) change around the plant, the requirements for fluid also change. The wicking medium 230 varies the flow rate (more or less water) in a natural self-compensating way by allowing the plant roots to draw only the amount of moisture from the growing medium as is dictated by the changing conditions. As such, plant stress may be eliminated or significantly reduced.

In the embodiments disclosed in FIGS. 1-3, the planting system 100 and wick assembly 200 is manufactured as an integral unit. However, in many cases, facilities already have dozens of pre-existing conventional planters. Rather than replace the existing conventional planters, the disclosure also contemplates a retrofit of the existing conventional planters with a wick assembly insert similar to the wick assembly 200 shown above, but which can be combined with the conventional planters.

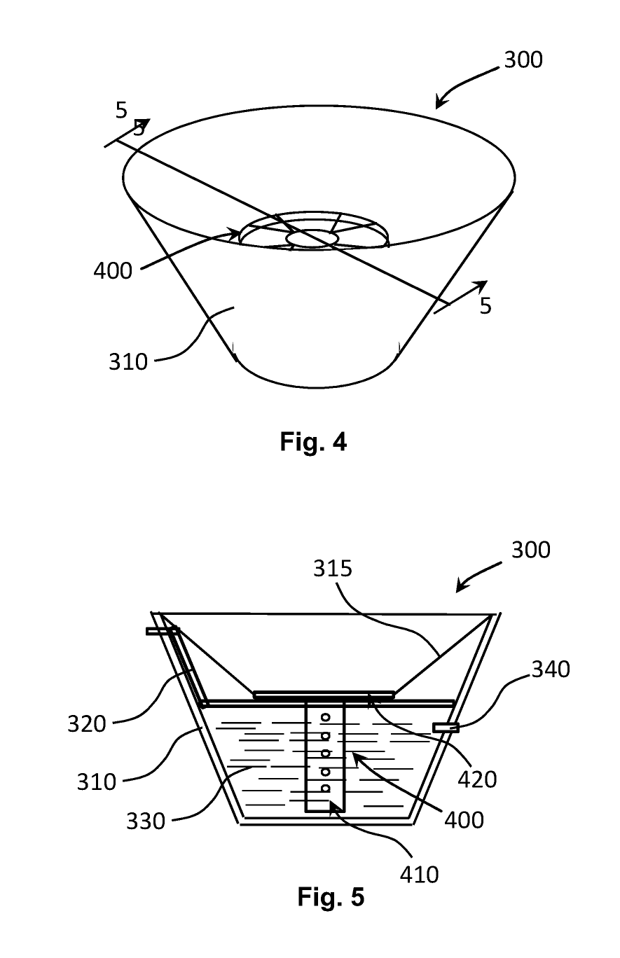

FIGS. 4 and 5 illustrate an embodiment of a planter system 300 for use in retrofitting a conventional planter 310 with a self-irrigating insert 315. The retrofit planter system 300 includes an existing planter 310, but includes a self-watering insert 315 which is custom molded to fit the interior shape of the existing planter 310. In one embodiment, the wick assembly insert 315 is thermoformed onto the interior surface of the existing planter 310, however, it should be appreciated that that other molding methods may be employed.

The self-irrigating insert 315 is molded to include a fill hole 320 for filling the reservoir 330 with water. A fill hole plug with a chain (not shown) can be provided at the top of the fill hole 320 to close the fill hole 320. An overflow opening 340 drilled into the side wall of the existing planter 310 prevents the reservoir 230 in the planter system 300 from being overfilled.

A wick assembly 400 is installed at the base of the self-watering insert 315, and includes a tubular column 410, a planting or irrigation tray 420 and a wicking medium (similar to the wicking material described above). Similar to the previous embodiments, the wicking medium is disposed internally of the tubular column and between the planting tray 420 and the growing medium of the potted plant. The tubular column 410 extends downwardly into the growth promoting fluid of the reservoir 430 such that apertures formed through the wall of the tubular column 410 allow the fluid to be absorbed by the internal wicking medium. Also in the same manner as the previous embodiments, the planting tray 420 receives the fluid by the capillary or wicking action of the wicking medium to provide a steady, prolonged flow of fluid to the growing medium of the potted plant. The insert 315 and wick assembly 400 can be fabricated by thermoforming or rotational, roll, blow, or injection molding.

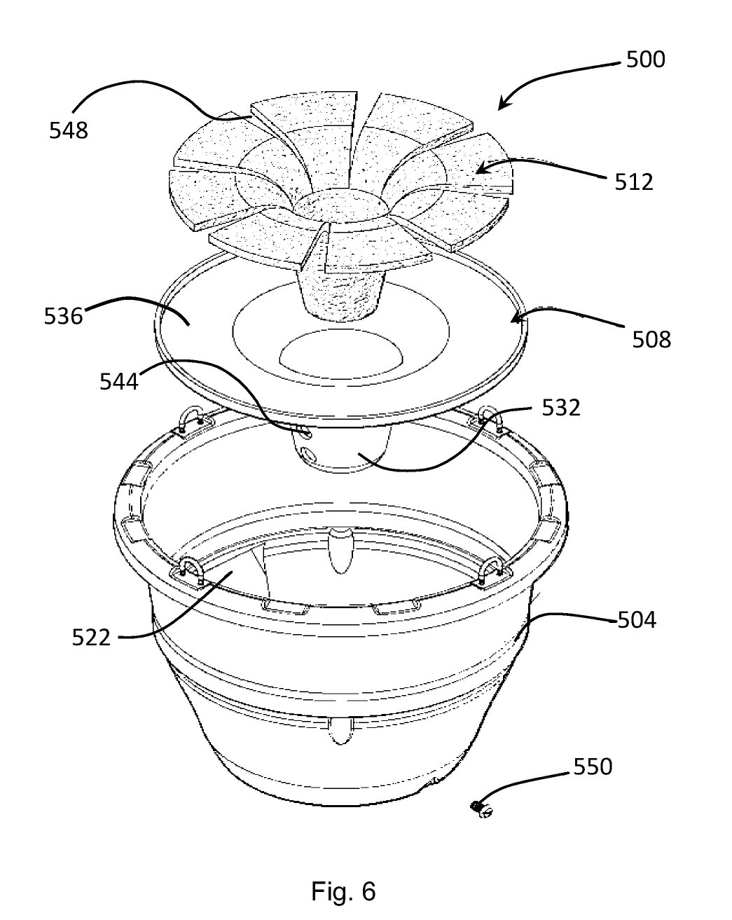

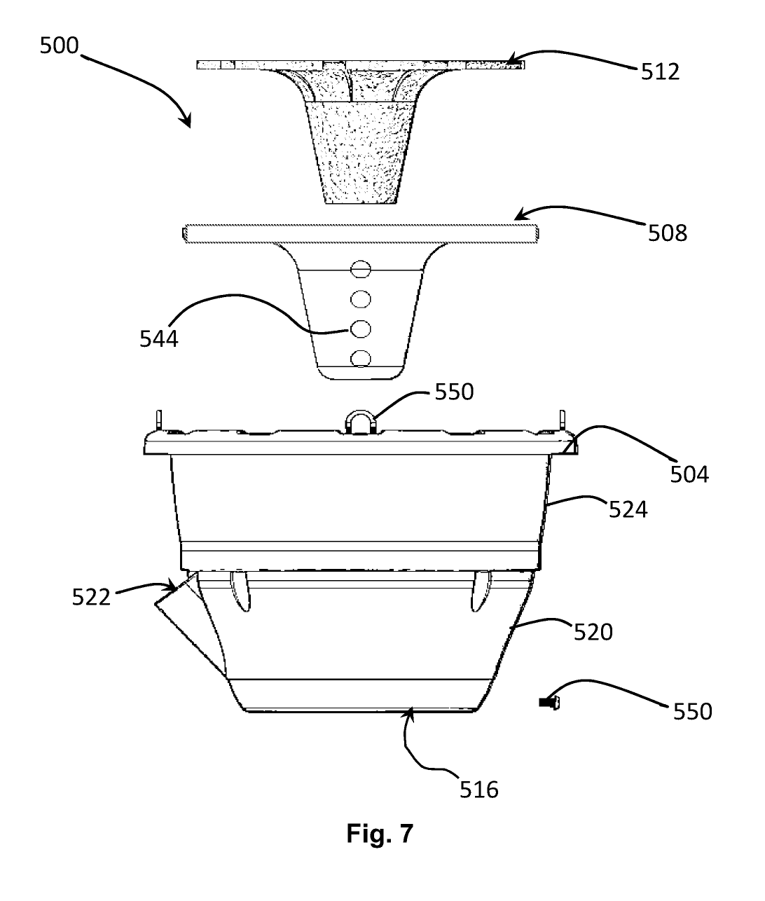

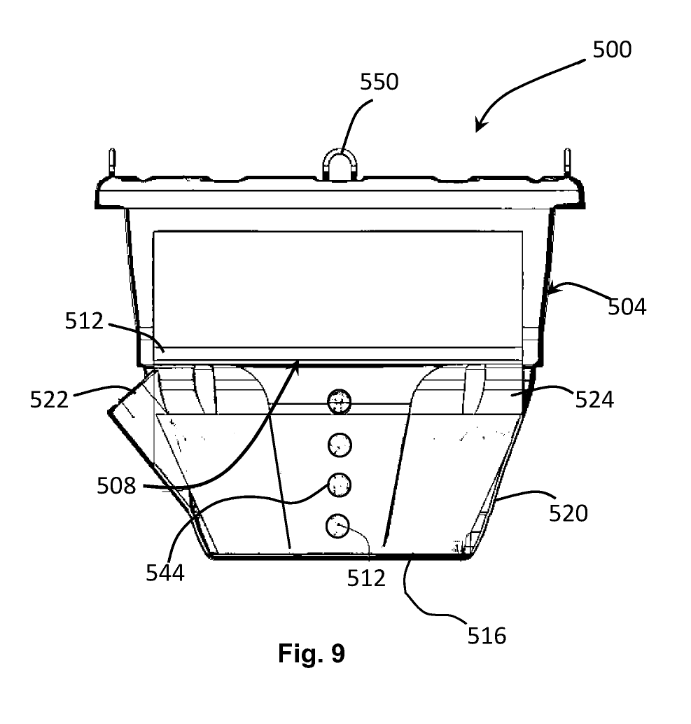

FIGS. 6-9 depict yet another embodiment of the self-watering planter system 500 (Hanging Basket) wherein the individual components are manufactured by a fiscally efficient thermoforming process. More specifically, two (2) of the three (3) component parts may be manufactured by a low-cost, thermoforming process. Thermoforming is a process wherein sheets of thermoplastic are: (i) heated to the glassine temperature Tg, i.e., between about three hundred to about seven hundred and twenty degrees Fahrenheit (300° F.-720° F.), (ii) placed over a mold, or array of molds replicating the inner/outer mold line of the component part, (iii) vacuum-formed into the mold, or array of molds, (iv) cooled so as to permit hardening or cross-linking of the thermoplastic, and trimmed or cut to remove the part, or parts, from the mold. Generally, this may be performed in a continuous process to reduce cost and improve efficiency.

In this embodiment, the planter system 500 includes a thermoformed planter 504, a thermoformed insert 508 and a tapered wick 512. Similar to the previous embodiments, the tapered wick 512 may be formed from recycled/reclaimed carpet stock, and, in the preferred embodiment, the tapered wick 512 includes a porous, absorptive carpet the carpet is die cut to fit the proper insert and planting tray.

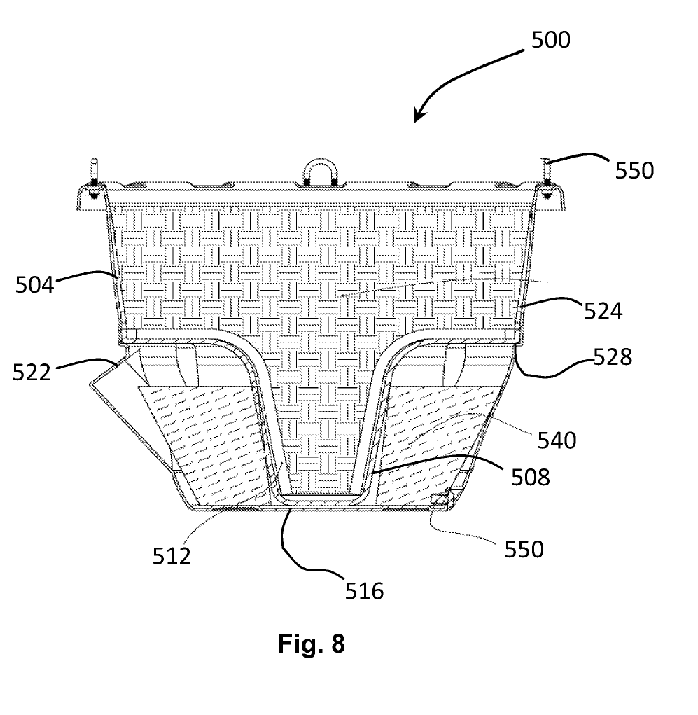

In the described embodiment, the planter system 500 includes a thermoformed planter 504 having a planar base portion 516, a tapered lower wall 520 defining a fill-port 522, a substantially cylindrically-shaped upper wall 524, and an annular lip 528 disposed between the upper and lower walls 520, 524 (best seen in FIG. 8). The thermoformed insert 508 comprises a tapered, cup-shaped base 532 and a ring or plate-shaped planter or irrigation tray 536 disposed radially outboard from a longitudinal axis of the cup-shaped base 532 (best seen in FIG. 6.)

The ring-shaped planter tray 536 nests or seats within the planter 500, i.e., against the annular lip 528 of the thermoformed planter 500 such that a toroidal or annular-shaped reservoir 540 is formed between the thermoformed planter 504 and the underside of the planter tray 536. The annular-shaped reservoir 540 may be filled with water through the fill port 522 formed in the lower wall 520 of the thermoformed planter 504. The tapered wick 512 (FIG. 6) is die cut and formed into the shape of the thermoformed insert 508 for transferring water from the annular-shaped reservoir 540 thru a plurality of vertically-arranged apertures 544 formed in the cup-shaped base 532 of the thermoformed insert 508. The apertures 544 may be aligned in a vertical row or column or randomly disbursed in the cup-shaped base 532.

The tapered wick 512 may be formed in the shape of the planter tray 536 or may be split into sections or radial strips 548. The wicking medium or material 512 may include a conventional bound carpet or carpet weave to mitigate cost and/or eliminate material waste. As with most planters 500 having a water reservoir, the annular reservoir 540 of the present application may include a drain plug for draining at the end of a season. While the drain plug may be located in a variety of locations, it will generally be located at the base portion 516 of the planter 504 or in the a tapered lower wall 520 thereof. It will be appreciated that the fill opening 522 may also serve as a drain or overflow aperture in the case of an overfill condition.

The tapered lower wall of the planter, and tapered, cup-shaped, base of the insert, facilitate fabrication by a thermoforming process. That is, the smooth curves and increased draft angle provided by the components of the planter system allow for the parts of the planter, i.e., the planter base, and insert to be thermoformed. The final product is stronger, more durable, and less expensive to produce in larger quantities. That is, the sheet material is more uniformly distributed, more pliable, more durable and stronger than a powder-formed, rotationally-molded, planter of the previous configuration.

This written description uses examples to disclose the invention, including the best mode, and also to enable any person skilled in the art to practice the invention, including making and using any devices or systems and performing any incorporated methods. The patentable scope of the invention may include other examples that occur to those skilled in the art.

1. A wick assembly for irrigating, aerating and delivering a supply of a growth promoting fluid to a potted plant, comprising:
a body having a tubular column defining a longitudinal axis and an irrigation tray extending radially outboard therefrom, the tubular column configured to receive a quantity of growth promoting fluid through at least one aperture disposed through a wall of the body, the irrigation tray configured to support a growing medium for growing the potted plant; and
a wicking medium disposed within at least a portion of the tubular column and the irrigation tray, the wicking medium receiving the supply of growth promoting fluid through the aperture and directing a flow of the fluid from the tubular column to the irrigation tray,
wherein the wicking medium facilitates a prolonged irrigation of the growing medium by delivering a uniform quantity of growth promoting fluid to the growing medium via the irrigation tray.

2. The wick assembly of claim 1 wherein the tubular column is configured to receive a growth of roots from the potted plant.

3. The wick assembly of claim 1 wherein the tubular column is configured to facilitate aeration of the roots of the potted plant.

4. The wick assembly of claim 1 wherein the irrigation tray defines a plane substantially normal to the longitudinal axis.

5. The wick assembly of claim 1 wherein the aperture is disposed through the body and into the tubular column.

6. The wick assembly of claim 1 further comprising at least one aperture disposed along an underside of the irrigation tray.

7. The wick assembly of claim 1 further comprising a plurality of apertures disposed along a wall of the tubular column.

8. The wick assembly of claim 1 wherein the wicking medium comprises a composite of chopped fabric fused together under heat and pressure to compliment the shape of the wick assembly housing.

9. A planting system for irrigating, aerating and delivering a supply of a growth promoting fluid to a potted plant, comprising:
a container defining a reservoir configured to store a supply of growth promoting fluid and a plant cavity configured to receive a growing medium; and,
a wick assembly configured to convey a flow of the growth promoting fluid to the growing medium in the plant cavity, the wick assembly including first and second portions which are in fluid communication by a wicking medium, the first portion including a first end of the wicking medium disposed in the reservoir to absorb the growth promoting fluid, the second portion including a second end of the wick assembly disposed in the plant cavity and in contact with the growing medium;
wherein the wicking medium provides a self-irrigating flow of growth promoting fluid from the first portion to the second portion of the wick assembly in response to a wicking action of the wicking medium;

10. The planting system of claim 9 wherein the first portion includes a tubular column defining a longitudinal axis and the second portion includes an irrigation tray extending radially outboard from the longitudinal axis.

11. The planting system of claim 9 further comprising a barometric tube disposed within the reservoir to provide an indication of an overfill condition.

12. The planting system of claim 10 wherein the irrigation tray defines a planar surface configured to support the wicking medium beneath the growing medium and provides an interface for transferring the growth promoting fluid from wicking medium to the growing medium.

13. The planting system of claim 10 wherein the tubular column defines a cavity for containing the wicking medium and is configured to receive the growth promoting fluid through at least one aperture disposed through the tubular column.

14. The planting system of claim 10 further comprising at least one aperture disposed along the underside of the irrigation tray.

15. The planting system of claim 10 further comprising a plurality of apertures disposed through a wall of the tubular column.

16. The planting system of claim 10 wherein the wicking medium comprises a composite of chopped fabric fused together in an autoclave in the shape of the wick assembly housing.

17. The planting system of claim 11 wherein the irrigation tray defines a plane substantially normal to the longitudinal axis.

18. A method for self-irrigating a potted plant comprising the steps of:
configuring a container so as to produce a cavity for holding a growing medium and a reservoir for containing a growth promoting fluid;
configuring a wick assembly for conveying the growth promoting fluid from the reservoir to the growing medium, and
configuring the wick assembly with a tubular column at one end and a planar irrigation tray at the other end, the tubular column being lined with a wicking medium and the irrigation tray being configured to support the wicking medium beneath the growing medium and providing an interface for transferring the growth promoting fluid from wicking medium to the growing medium.

19. The method of claim 18 further comprising the step of:
fabricating the wick assembly by a thermoforming process.

20. The method of claim 18 further comprising the step of:
fabricating the container by a thermoforming process.
